(19) United States
(12) Patent Application Publication
(10) Pub. No.: US 2012/0164507 A1
(43) Pub. Date: Jun. 28, 2012

(54) BATTERY COOLING SYSTEM

(75) Inventors: Walter Lachenmeier, Sankt Augustin (DE); Andreas Gutsch, Luedinghausen (DE); Tim Schaefer, Niedersachswerfen (DE); Markus Wohnig, Dresden (DE)

(73) Assignee: LI-TEC BATTERY GMBH, Kamenz (DE)

(21) Appl. No.: 13/148,841

(22) PCT Filed: Feb. 2, 2010
(86) PCT No.: PCT/EP10/00625

§ 371 Date: Mar. 13, 2012

(30) Foreign Application Priority Data
Feb. 10, 2009 (DE) 10-2009-008-222.0

(51) Int. Cl. H01M 10/50

(52) U.S. Cl. 429/120

(57) ABSTRACT

The invention relates to a battery (1) comprising at least one, in particular several battery cells (2), especially square battery cells. The battery cells (2) are accommodated in a battery housing (5) and at least one heat exchanger unit (3) is located inside the battery housing.

Priority application DE 10 2009 008 222.0 is fully incorporated by reference into the present application.

The present invention relates to a battery, which is used in particular in an electrically driven motor vehicle.

From DE 602 13 474 T2 an electrochemical storage unit is known which has several electrochemical cells which are arranged spaced apart from each other. Between two side faces of the electrochemical cells a cooling bellows is arranged, which touches the side faces of the electrochemical cells. A heat transfer medium flows through the cooling bellows.

The present invention is based on the problem of improving a battery of the type named in the introduction.

The problem forming the basis of the invention is solved by a battery comprising at least one, in particular several, battery cells, especially flat battery cells, wherein the battery cells are accommodated in a battery housing and wherein at least one heat exchanger unit is located inside the battery housing.

Battery or respectively battery cell are basically to be understood to mean non-rechargeable primary batteries or respectively primary battery cells and also re-chargeable secondary batteries or respectively secondary battery cells. A battery cell comprises here in particular an electric cell which has at least two electrodes and electrolyte arranged between two electrodes. Electrical energy is stored here in the electric cell, wherein the electric cell also serves for the conversion of chemical and electrical energy. If the battery cell is a secondary battery cell, electrical energy can also be converted into chemical energy. A heat exchanger unit here is a device which basically transfers heat from one substance to another. Preferably, the heat exchanger unit transfers heat here from an interior of the battery housing to a cooling medium.

The heat exchanger unit preferably has a number of tubes through which a first cooling medium, in particular a gaseous cooling medium or a liquid cooling medium, can flow. The first cooling medium here can be substance to which heat is transferred, which is to be conveyed away from the interior of the housing. The tubes can direct the first cooling medium here through various sections of the interior of the housing and can also direct the cooling medium through a housing wall out of the battery, where the cooling fluid can preferably be cooled by means of a further external heat exchanger. Preferably, a heat exchanger unit is fastened at least indirectly, in particular directly, on the battery housing.

Preferably, a second cooling medium, in particular a gaseous or a liquid cooling medium, is arranged in an intermediate space between the heat exchanger unit and the battery cell. The designation “second” cooling medium is not to be understood such that basically two different cooling media have to be present. Rather, the designation serves for delimitation with respect to a first cooling medium. In this respect, the “second” cooling medium can also be provided without a “first” cooling medium being provided. The second cooling medium can serve for a heat transport between the battery cell and the heat exchanger unit. Therefore, the heat removal from the battery cell towards the heat exchanger unit is promoted. Gaseous or liquid cooling media have the advantage that owing to their flowability they can convey heat away more quickly than solid cooling media. Preferably, a heat-conductive paste can be used. Preferably, a pump is provided, which is arranged in particular inside the battery housing. The pump can set in motion the second cooling medium, which can be arranged inside the battery housing. The term “pump” here includes all arrangements which can accelerate or put under pressure a flowable medium, namely preferably a fan or a compressor. The second cooling medium can transfer heat in an improved manner when it is in motion. The second cooling medium can, however, also be a heat-conductive foil, which is preferably in direct contact with the battery cell. The heat-conductive foil is distinguished, with high heat transfer capability, by a light weight.

Preferably, the second cooling medium can move freely between the battery housing, the heat exchanger unit and the battery cell. The second cooling medium is not accommodated here in additional tubes or receptacles.

Preferably, at least one flow-conducting element, in particular an air-conducting element and/or a flow-deflecting element is arranged inside the battery housing. Such a flow-conducting element can direct accelerated cooling medium, in particular accelerated second cooling medium, in certain directions, which are suited for a particularly good removal of heat. A flow-conducting element can preferably be arranged here such that it directs a flow at sites of the battery cell which are particularly warm or hot and therefore require an increased removal of heat. In addition, a flow-conducting element can be arranged such that it directs a flow at sites of the battery housing or heat exchanger unit which are particularly cold. The terms particularly hot or particularly cold are not to be understood as being absolute, but rather as being relative.

Preferably, the flow-conducting elements comprise at least one flow-deflecting element. Preferably, such a flow-deflecting element brings about a deflection of a flow of at least 45°, in particular 90°, in particular at least 135°, in particular approximately 180°. Through such a deflection, a type of circular or circulating flow can be brought about inside the battery housing. Such flows bring about an improved removal of heat, in particular at angled regions of the battery.

Preferably, at least two flow channels are formed inside the battery housing. The flow channels can be formed here by flow-conducting elements. In particular, one flow return channel and one flow forward channel can be formed inside the battery housing. A flow forward channel can constitute here in particular a flow channel in which a flow is directed away from a pump in the direction towards a battery cell. Here, a flow return channel can constitute in particular a flow channel in which a flow can be directed away from a battery cell towards a pump.

Preferably, a battery cell has at least one, in particular one, two or three heat transfer sections. The heat transfer sections can be formed on a surface of the battery cell or can also be arranged on a heat-conducting plate of the battery cell. Preferably, a heat transfer surface is aligned parallel to a flow direction. A heat transfer surface can be arranged here on a heat transfer section. The flow direction can refer to a flow direction of the second cooling medium. Through the fact that the flow direction runs parallel to a heat transfer surface, an improved heat transfer can take place between the heat transfer surface and a flow. Preferably, the heat transfer surface is arranged here inside a flow channel, so that the heat transfer surface can come into contact with a flowing medium.

Alternatively or in combination with the above-mentioned possibilities, a heat exchanger unit can be in solid body contact with a surface of the battery cell. The heat removal can be brought about here at least partially, in particular completely, via the solid body contact. The heat exchanger unit can be in solid body contact here with at least one heat-conducting plate of the battery cell. A heat-conducting plate can extend here through a casing of the battery cell and therefore have sections which are situated inside the battery cell and sections which are situated outside the battery cell. Hereby, an improved transferability of heat can be promoted from the interior of the battery cell towards the exterior. If this heat-conducting plate is in solid body contact with the heat exchanger unit, the heat transferability is further promoted.

Preferably, the battery cell has a fastening flange. The fastening flange can be a lateral boundary of the battery cell at least on one side of the battery cell. At the fastening flange, the battery cell can be secured in a force-fitting or form-fitting manner to other components. Here, the fastening flange preferably has a certain stability of form. A squeezing of the battery cell itself can be avoided here on fastening onto the fastening flange.

Preferably, at least one spacer element, in particular a spacer strip, is arranged between adjacent battery cells, in particular between fastening flanges of adjacent battery cells. The spacer element can hold the battery cells at a distance from each other, whereby also a defined distance of the batteries with respect to each other remains guaranteed. The spacer element can also, at the same time, be a means here by which a heat exchanger unit is in solid body contact with the surface of the battery cell. The spacer element can extend here along an edge of the battery cell and preferably fill an intermediate space between the battery cell and the battery housing at least partially, in particular completely.

Preferably, at least one tube of the heat exchanger unit is passed through by a bore of the battery cell. The bore can be arranged here on a fastening flange of the battery cell. The fastening flange can be arranged on a heat-conducting plate of the battery cell. Alternatively or in combination with this, at least one tube of a heat exchanger unit can be passed through in a bore of a spacer element. In particular, at least one tube of a heat exchanger unit can be passed through both in a bore of a spacer element and also in a bore of the battery cell. The tube of the heat exchanger unit is in direct solid body contact with the battery cell, if in particular the tube of the heat exchanger unit is passed through a bore of the battery cell. The heat exchanger unit can be in indirect solid body contact with the battery cell when a tube of the heat exchanger unit is passed through in particular in a bore of a spacer element. Preferably the spacer element is produced from heat-conducting material.

Preferably, a tube of a heat exchanger unit has a thread. Preferably at least one tube of a heat exchanger unit can be braced by means of screwing means with respect to a spacer element and/or to a battery cell. A nut can be screwed here onto a thread of a tube. This makes possible a simple and reliable connection of the heat exchanger unit and spacer element and/or battery cell.

Preferably, the heat exchanger unit is connected to a vehicle cooling circuit. Here, the cooling function of the engine cooler can also be used for cooling the battery. This is advantageous in particular in hybrid vehicles.

A heat-conducting plate is preferably chamfered laterally by a width of the battery cell. A chamfer by in particular 90° makes it possible that a section of the heat-conducting plate can be aligned in the flow direction of a medium flowing past the battery cell. The preferable chamfer by a width of the battery cell can bring it about that the chamfer does not extend beyond a width extent of the battery cell. By means of their chamfers, adjacent battery cells can form a closed uniform onflow surface, which can be flowed against by a cooling medium.

Heat-conducting plates can be provided, which are constructed integrally with battery cells. Alternatively, heat-conducting plates can be constructed separately from battery cells. In integrally constructed heat-conducting plates, the heat-conducting plates preferably penetrate the battery cells and form a heat-conducting path from inside the battery cell towards the exterior. Preferably, a heat-conducting plate is produced from aluminium. Aluminium has a good thermal conductivity here with a relatively low weight. A heat-conducting plate has as a maximum a thickness of 2 mm, in particular approximately 1 mm.

Preferably, a heat exchanger unit has several tubes, wherein tubes can be connected with each other by means of a collecting arrangement. The collecting arrangement can separate a flow or respectively can collect several flows to form one single flow.

Preferably, a heat-conducting element can be in contact indirectly with the surface of a battery cell and directly with a surface of the battery housing. A heat-conducting element can be formed here by a heat-conducting plate or a spacer element.

The invention is explained in further detail with the aid of the following figures, in which are shown:

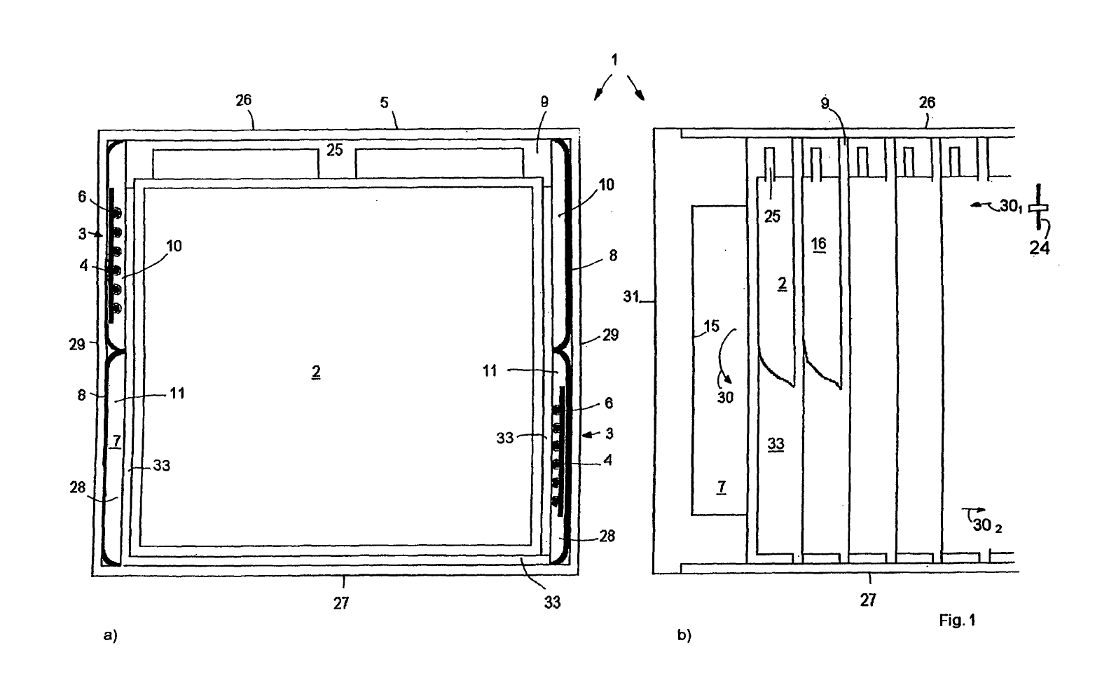

FIG. 1 a battery according to the invention in a first embodiment
a) in front view,
b) in side view;

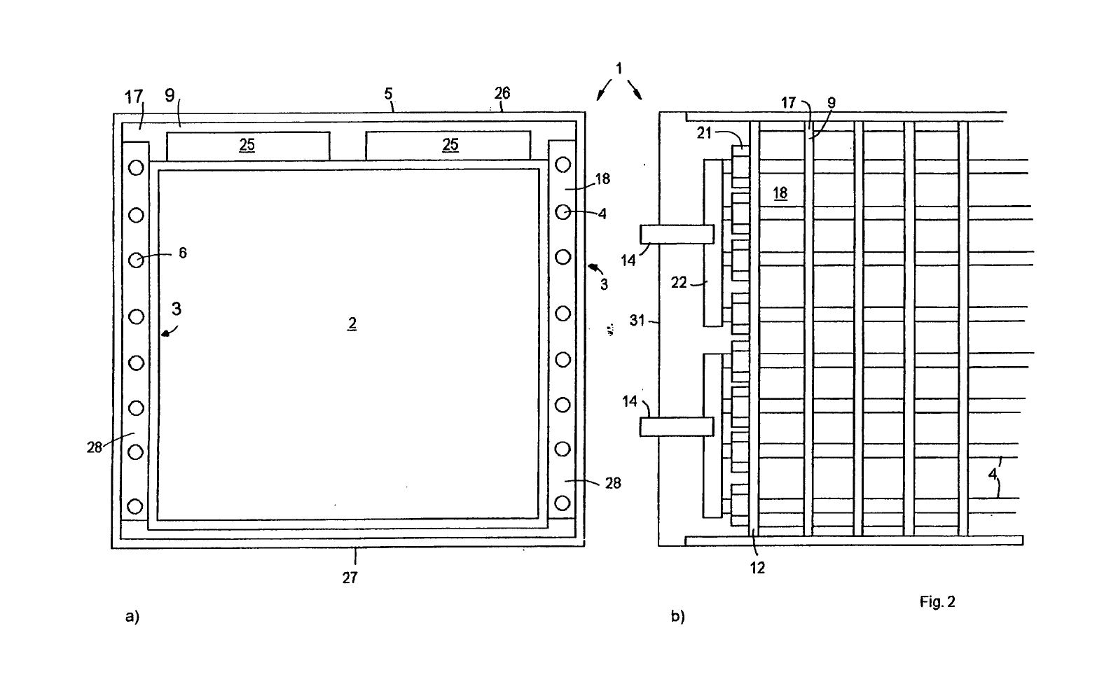

FIG. 2 a battery according to the invention in a second embodiment
a) in front view,
b) in side view;

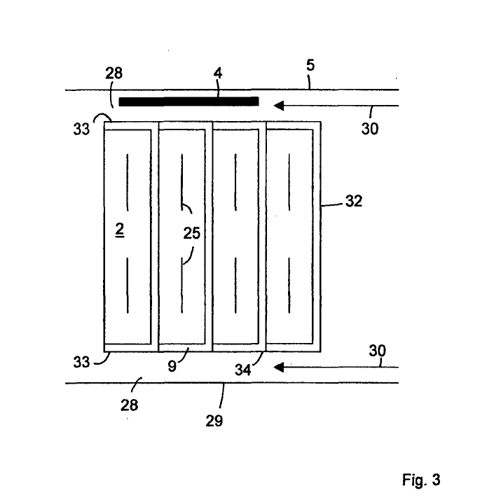

FIG. 3 a battery cell according to FIG. 1 in top view;

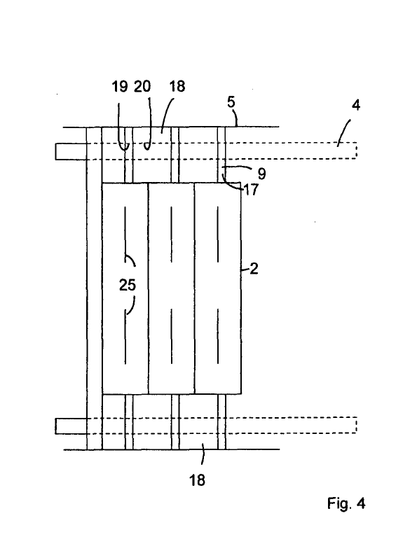

FIG. 4 a battery cell according to FIG. 2 in top view.

FIG. 1 shows a battery 1 according to the invention in a first embodiment, wherein in both illustrations according to FIG. 1 a housing wall has been removed, so that the interior of the battery 1 can be seen. The battery 1 has a battery housing 5 which seals an interior of the battery hermetically with respect to the exterior, i.e. in a gas-tight and fluid-tight manner. Unaffected by this, the possibility remains that cooling medium which is provided inside a heat exchanger, can be conveyed through tubes from the interior of the battery towards the exterior, if applicable.

The battery 1 has several battery cells 2, which are configured as flat battery cells. The flat battery cells are constructed as secondary battery cells, so that they are rechargeable. The battery cells 2, as can be seen in particular in FIG. 1 b), are arranged one behind the other, wherein in total five of the battery cells 2 can be seen. Further battery cells 2, which are not illustrated, are arranged inside the battery housing 5. Separately from the battery cells 2, heat-conducting plates 9 are provided, which are arranged respectively between two battery cells 2. The heat-conducting plates 9 are arranged here directly on surfaces 16 of adjacent battery cells 2, so that the battery cells 2 are in contact with the heat-conducting plates 9.

The battery cells 2 have respectively two current collectors 25, which extend above out of a casing of the battery cell 2. The current collectors 25 are in contact here with electrodes arranged inside the battery cell 2. The current collectors 25 constitute the outer current connections of the battery cell 2.

Within the battery housing 5, two heat exchanger units 3 are arranged, which are fastened to air-conducting elements 8 via fastening means which are not shown. The air-conducting elements 8 are in turn securely connected with the battery housing 5. The flow-conducting elements 8 are formed by an aluminium sheet profile. The heat exchanger unit 3 is therefore fastened indirectly to the battery housing 5.

The heat exchanger units 3 comprise several tubes 4, through which a first liquid cooling medium 6 flows. The tubes 4 of the heat exchanger unit 3 can also be connected with a vehicle cooling circuit outside the battery cell 2, to which further batteries can be connected.

The interior of the battery 1, which is surrounded by the battery housing 5, contains in addition to the components already mentioned, a gaseous second cooling medium 7, which can move freely inside the battery housing 5. The second cooling medium 7 can be air, but also can be another gaseous medium, which in particular is under pressure. The movement of the second cooling medium 7 is, however, influenced via air-conducting elements 8 and a flow-deflecting element 15. In addition, a fan 24 is provided inside the battery housing 5, which accelerates the second cooling medium 7.

The heat-conducting plates 9 extend from a cover surface 26 up to a base surface 27 of the battery housing 5. Therefore, only one intermediate space 28 remains for the second cooling medium between the heat-conducting plates 9 and the lateral boundary walls 29 of the battery housing, in order to flow in longitudinal direction of the battery 1, wherein the longitudinal direction runs substantially perpendicularly to the extent of the heat-conducting plates 9 and is marked by arrows 30. In the intermediate space 28, the air-conducting elements 8 are arranged which respectively divides a left-hand intermediate space and a right-hand intermediate space into an upper region, namely a flow forward channel 10 and into a lower gap region, namely a flow return channel 11. As can be seen by the arrows, the flow direction 30₁ in the flow forward channel is opposed to the flow direction 30₂ in the flow return channel. At an axial end 31, the flow-deflecting element 15 is arranged, which brings about a deflection of the flow 30 through 180°. Such a flow-deflecting element 15 is also provided at the other axial end, which is not illustrated, of the battery housing 5. In the flow forward channel 10 and in the flow return channel 11, a heat exchanger unit 3 is respectively arranged.

The second cooling medium 7 can alternatively also be embodied as a liquid cooling medium. In this case, the fan 24 is designed as a pump.

FIG. 2 shows a battery 1 according to the invention in a second embodiment, wherein in both illustrations according to FIG. 2 a housing wall has been removed, so that the interior of the battery 1 can be seen. The battery 1 of the second embodiment corresponds in parts to the battery in the first embodiment according to FIG. 1. Only differences from the battery according to the first embodiment will be entered into in the following.

The battery 1 comprises several battery cells 2, which are configured as flat battery cells. The flat battery cells 2 are constructed integrally with heat-conducting plates 9. Here, the heat-conducting plates 9, as will be explained in further detail below, extend through a casing of the battery cells and therefore have sections arranged inside the casing and sections arranged outside the casing. The heat-conducting plate is therefore a component of the battery cell 2. Here, the heat-conducting plates 9 form laterally arranged fastening flanges 17, to which the battery cell 2 can be fastened in the battery housing 5. The fastening flanges 17 have bores 19, through which tubes 4 of a heat exchanger unit 3 are passed. Individual bores 19 are arranged here coaxially to bores 19 of other battery cells 2, so that a straight-running tube 4 is passed at the same time through bores 19 of several battery cells 2. A closure plate 12 is provided on a battery cell 2, which constitutes an outermost battery cell 2, i.e. this battery cell 2 adjoins another battery cell only by one side.

As will be further described later, the fastening flange 17 is configured so as to be narrower in longitudinal direction than the entire body of the battery cell 2. In this respect, in the case of battery cells 2 which are situated in abutment, an intermediate space 28 is produced between fastening flanges 17 of the battery cells 2, in which respectively a spacer strip 18 is arranged. The spacer strip 18, in an analogous manner to the fastening flanges 17 and the closure plate 12, has bores 20, which are arranged coaxially to the bores 19 of the fastening flanges 17 and of the closure plate 12. In this respect, the tubes 4 can also project through bores of the closure plate 12. The spacer strip 18 is produced from a heat-conducting material and lies both against a surface of the casing of the battery cell 2 and also against a surface of the battery housing 5 and therefore constitutes an indirect heat-conducting connection between the battery cell 2 and the battery housing 5. In FIG. 2 the tubes 4 are given continuous lines. This serves only for a better illustration. In reality, however, the tubes 4 are covered by the spacer strips 18 and are therefore not visible. The spacer strips completely fill the intermediate space 28 between the battery cell 2 and the battery housing.

The tubes 4 have on the end side a thread, which is not illustrated, on which respectively a nut 21 is screwed. Here, the nuts screw the tubes 4 with respect to the closure plate 12. In FIG. 2b only nuts on the left-hand side of the stack of battery cells 2 are shown. Likewise, not illustrated here, nuts are provided on the right-hand side of the stack of battery cells 2, which are screwed on threads of the tubes 4. Therefore, the battery cells 2 are braced between two connection plates 12 on the tubes 4 together with spacer strips 18 and the heat-conducting plates 9 of the battery cells 2.

The tubes 4 are partially brought together via collecting arrangements 22. A collecting tube, which is connected with the collecting arrangement 22, penetrates a wall of the battery housing 5 and therefore constitutes an outer tube connection of the heat exchanger unit 3. A liquid first cooling medium is arranged in the heat exchanger unit 3. Unlike in the first embodiment, no second cooling medium is provided. A heat conduction away from the surface of a battery cell 2 takes place either directly on contact surfaces between the tubes 4 and the fastening flange 17 or via solid body contact between the surface 16 of the battery cell 2 and the spacer strips 18.

FIG. 3 shows a battery cell 2 with a heat-conducting plate 9, as is used in a battery cell according to FIG. 1. Here, the battery cell 2 and the heat-conducting plate 9 are viewed from above. The battery cell 2 has a rectangular cross-section. The heat-conducting plate 9 is in abutment here on a side face 32 of the battery cell 2. The heat-conducting plates 9 have lateral chamfers 33, wherein the chamfers 33 extend parallel to the flow directions 30₁, 30₂ and parallel to the tubes 4. The heat-conducting plate 9 is therefore configured in a U-shape, viewed in top view, and surrounds the battery cell 2 partially here. A further chamfer on the underside of the heat-conducting plate 9 is not illustrated, which rests on a base surface 27 of the battery housing 5, and on which a base surface of the battery cell 2 likewise rests. The lateral chamfers have a width here which corresponds to a width of the battery cell 2. In this respect, the chamfers 33 of several heat-conducting plates 9, lying adjacent to each other and separated by battery cells 2, form a closed onflow surface 34.

FIG. 4 shows a battery cell 2 with a heat-conducting plate 9, as is used in a battery cell according to FIG. 2. The battery cell 2 and the heat-conducting plate 9 are viewed here from above. The battery cell 2 has a rectangular cross-section.

Several battery cells 2 lie here on side faces 32 directly adjacent to each other. The heat-conducting plates 9 are arranged approximately centrally on a width of the battery cells 2 and penetrate the battery cell 2 in their entire extent. The heat-conducting plates 9 are configured to be flat, having no chamfer. The tubes 4 can be seen with dashed lines, extending through the bores 19, 20 of the heat-conducting plate 9 and of the spacer strips 18. At one end of the stack of battery cells 2, a closure plate 12 can be seen. The threads and screwing means, which have already been mentioned, are not illustrated in FIG. 4. It can be clearly seen that the spacer element is in contact both directly with the surface 16 of the battery cell and also directly with a surface of the battery housing.

### LIST OF REFERENCE NUMBERS

1 battery
2 battery cell
3 heat exchanger unit
4 tube
5 battery housing
6 first cooling medium
7 second cooling medium
8 air-conducting element
9 heat-conducting plate
10 flow forward channel
11 flow return channel
12 closure plate
13 heat transfer section
14 tube connections
15 flow-deflecting element
16 surface
17 fastening flange
18 spacer strip
19 bore
20 bore
21 nut
22 collecting arrangement
24 fan
25 current collector
26 cover surface
27 base surface
28 intermediate space
29 side wall
30 flow direction
31 axial end
32 side face
33 chamfer
34 onflow surface

1.-30. (canceled)

31. Battery (1), comprising at least one square flat battery cells, wherein the battery cells (2) are accommodated in a battery housing (5), and
wherein at least one heat exchanger unit (3) is located inside the battery housing (5),
wherein
the at least one heat exchanger unit (3) has a number of tubes (4), through which a first cooling medium (6) can flow, —the at least one battery cell (2) has a fastening flange (17), and that
at least one tube (4) at least of at least one heat exchanger unit (3) is passed through a bore (20) of the battery cell (2) on the fastening flange (17).

32. The battery (1) according to claim 31,
wherein
a heat exchanger unit (3) is fastened at least indirectly to the battery housing (5).

33. The battery (1) according to claim 32,
wherein
in an intermediate space (28) between the heat exchanger unit (3) and the battery cell (2) a second cooling medium (7) is arranged.

34. The battery (1) according to claim 33,
wherein
a pump (24) is provided, which is arranged inside the battery housing (5).

35. The battery (1) according to claim 34,
wherein
inside the battery housing (5) at least one flow-conducting element or a flow-deflecting element (15) is arranged.

36. The battery (1) according to claim 35,
wherein
inside the battery housing (5) at least two flow channels (10, 11) are formed through flow-conducting elements (8).

37. The battery (1) according to claim 36,
wherein
inside the battery channel a flow return channel (11) and a flow forward channel (10) is formed.

38. The battery (1) according to claim 37,
wherein
the flow-conducting elements (8) comprise at least one flow-deflecting element (15), which makes possible a deflection of a flow of at least 45°.

39. The battery (1) according to claim 38,
wherein
a battery cell (2) has at least one heat transfer sections (13).

40. The battery (1) according to claim 39,
wherein
a heat transfer surface (25) is aligned parallel to a flow direction (14).

41. The battery (1) according to claim 40,
wherein
